(19) United States
(12) Patent Application Publication
(10) Pub. No.: US 2009/0206996 A1
(43) Pub. Date: Aug. 20, 2009

(54) Phone number identifiers for ISO 11784/85 compatible transponders and associated systems and methods

(76) Inventors: Joseph V. Masin, Santa Barbara, CA (US); Barbara P. Masin, Santa Barbara, CA (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/070,497

(22) Filed: Feb. 19, 2008

(51) Int. Cl. H04B 7/00

(52) U.S. Cl. 340/10.1

(57) ABSTRACT

Systems and methods are disclosed for identifying animals with radio frequency identification transponders using phone number identifiers stored within ISO 11784 code structures in ISO 11784/85 compatible implantable transponders. These phone identification (ID) transponders feature unique telephone numbers, allowing pets to be returned to their owners through direct phone contact, for which ISO 11784 standard does not provide. The phone number information can be stored prior to implantation or after implantation depending upon the type of transponders being utilized. More particularly, within the ISO 11784 code structure, phone number related country codes are stored in bits 17-26, and phone numbers are stored in bits 27-64. Un-used digits can be filled by adding leading zeros or trailing zeros or both, as desired. In addition, variations can be provided to account for particular country conditions, such as 12-digit phone numbers in Germany.

### TECHNICAL FIELD OF THE INVENTION

The present invention relates generally to miniature electronic devices and more particularly to miniature transponder devices suitable for implantation in animals.

### BACKGROUND

Prior RFID (radio frequency identification) tags exist that are used to help identify animals and companion animals (i.e., pets), in particular. RFID tags typically include an electronic assembly inside of a protective housing, and the RFID tag can be used for assets management, container safety inspection purposes, fraud prevention, ownership identification or other purposes. One application for such RFID tags, for example, is the use of RFID tags to help identify and recover lost pets. These RFID tags can be implanted into the pet, for example, near the pet's neck or shoulder, and the pet tag can then be read to determine information about the pet.

The ISO 11784/85 standard is directed to RFID tags for companion animals or pets and applies as well to livestock. The ISO 11785 standard addresses how the RFID scanner/reader communicates with the RFID tag, and the ISO 11784 standard describes the chip/transponder that forms the RFID pet tag. In part, the ISO 11784 standard specifies a unique identification (ID) number for each individual animal tagged with a pet tag. More particularly, the ISO 11784 standard sets forth the following code structure that is stored in memory within the pet tag.

TABLE 1
ISO 11784 CODE STRUCTURE

| Bit no. | Information | Combinations |
|---|---|---|
| 1 | Flag for animal (1) or non-animal (0) | 2 |
| | application | |
| 2-15 | Reserved field | 16.384 |
| 16 | Flag indicating the existence of a data block | 2 |
| | (1) or no data block (0) | |
| 17-26 | ISO 3166 country code (up to 899) or | 1.024 |
| | Manufacturers code (900-998) or | |
| | 999 to indicate test transponder | |
| 27-64 | Individual identification code | 274.877.906.944 |

As set forth in the ISO 11784 standard for the code structure, bit number 1 signals whether the transponder is used for animal identification or not. In all animal applications this bit shall be “1”. Bit numbers 1-15 (fourteen bits) of the code structure are reserved for future use. Their values are to be set to “0”. Bit number 16 signals that additional data is to be received (e.g., physiological data, measured by a device which combines identification and monitoring). This bit is set to “1” if additional information is appended to the identification code; otherwise it is set to “0”. Bit numbers 17-26 contain either a country code (up to 899), according to ISO 3166, or a manufacturer's code (900-998). Code 999 is used to indicate that the transponder is a test transponder and need not contain a unique identification number. As further set forth in the ISO 11784/85 standard, ISO set up an authorized central registration authority to ensure unique manufacturers' codes. Bit numbers 27-64 set forth a unique 12-digit pet identifier number (i.e., 274,877,906,944 possible combinations based upon 38-bits of the ISO 11784 code structure). The combination of the country code or the manufacturer's code with the individual identification code is intended to provide a world-wide unique identification number.

FIG. 2A (Prior Art) provides a block diagram for a system 200 including a pet tag 202 and a pet tag reader 204. The pet tag 202 is an ISO 11784/85 compatible pet tag and in part stores a unique pet ID number 206 as set forth in the ISO 11784 standard. When the pet tag 202 is read by pet tag reader 204, a pet ID output 208 is provided by the reader 204. Where the pet is a lost pet, the locating entity, such as a veterinarian or shelter, can use the unique pet ID number to locate information about the owner. However, this procedure is only as good as the uniqueness of the ID numbers, the registration of the ID numbers by pet owners with centralized pet registration database and the maintenance of the pet registration database.

Because the ISO (International Standards Organization) standard is by its nature an open standard, there are no means to enforce the provisions of this standard and consequently no means to enforce any unique coding presumed by the standard. Only the parties enrolled in the manufacturer code registry administered by ISO/ICAR (International Committee for Animal Recording) may have some incentive to adhere to the program, and they have no means to prevent cloning of the manufacturer codes ICAR has assigned them for a fee. ICAR, which has been tasked to issue the manufacturer's code numbers in return for fees paid by applicants, does not have the means to enforce the registration.

It is also noted that the ISO 11784/85 standard was conceptualized before the advent of sufficiently miniaturized OTP (one time programmable) circuitries and read-write integrated circuits (ICs) suitable for incorporation in animal implantable transponders. As such, the ISO 11784 standard sets forth a code structure that could be implemented with unique pet identification numbers that would be fixed in the pet tag when it was manufactured. Today transponders or pet tags exist, however, that can be custom programmed and potentially reprogrammed by the end user, sometimes even after they have been implanted into the animal.

The original idea behind the ISO 11784 standard was that there would be centralized databases storing the “unique” code numbers for each pet along with owner and veterinarian information. Today, there are probably several hundred such databases which often do not share information with each other or cooperate with each other. This is particularly true with companion animals (e.g., cats and dogs). Nevertheless, some countries and a number of communities have enacted laws demanding identification of companion animals using RFID pet tags, without providing the infrastructure (centralized databases) to support the requirement.

Hundreds of thousands of readers capable of detecting the ISO 11784/85 compatible transponders have been placed in animal shelters and veterinarian offices around the world and are beginning to be placed in the United States. As of now, for companion animals, the transponder pet ID number must be registered in a database together with current owner information in order to accomplish the objective of reuniting a lost pet with its owner. Many owners who have their pets micro-chipped, however, do not take steps to register their animals in a database. Consequently, when the animal is picked up by animal control, no one knows which database to call, and, as stated before, the animal may not be registered at all. Registration costs money, requires an extra step on the part of the owner and in some cases also requires annual payments by the pet owner to stay active in the registry.

An ISO 14223 standard has recently been proposed for advanced transponders for the identification of animals, including companion animals. These advanced transponders are configured with additional memory that can be used to store additional information concerning the companion animal. In part, the code structure for the ISO 14223 standard includes the ISO 11784 code structure along with additional fields. Within these additional fields are fields used to identify the registration databases where the pet tag is registered. And within these additional fields are fields that can be used to store pet owner information including phone numbers associated with the pet owner.

FIG. 2B (Prior Art) provides a block diagram for a system 250 including a pet tag 252 and a pet tag reader 254. The pet tag 252 is an ISO 14223 compatible pet tag and in part includes the ISO 11784 code structure and stores the unique pet ID number 206 as set forth in the ISO 11784 standard. The pet tag 252 can also be used to store additional information 256 according to the ISO 14223 standard, including owner phone number information 256. When the pet tag 252 is read by pet tag reader 254, a pet ID output 208 is provided by the reader 204. In addition to other information stored as part of the ISO 14223, an owner phone number output 258 can also be provided. Where the pet is a lost pet, the locating entity, such as a veterinarian or shelter, can use the unique pet ID number to locate information about the owner. However, this procedure is again only as good as the uniqueness of the ID numbers, the registration of the ID numbers by pet owners and the maintenance of the pet registration database. If the owner has chosen to include owner phone number information, the phone number information can also be used to contact the owner. One disadvantage with the ISO 14223 compatible pet tags, however, is that they will likely need to be larger, more complex and more expensive than the prior ISO 11784/85 compatible pet tags. Another disadvantage is that the current installed base of readers in shelters and veterinary practices around the world cannot detect and display the additional information for this new standard.

### SUMMARY OF THE INVENTION

Systems and methods are disclosed for identifying animals with radio frequency identification transponders using phone number identifiers stored within ISO 11784 code structures in ISO 11784/85 compatible implantable transponders. The phone number information can be stored prior to implantation or after implantation depending upon the type of transponders being utilized. More particularly, phone number related country codes are stored in bits 17-26 of the ISO 11784 code structure within the memory circuitry within the transponder. And the phone number related country codes can be one to three digit country codes as specified in the ITU E.164 standard. Phone numbers are stored in bits 27-64 of the ISO 11784 code structure within the memory circuitry within the transponder. Un-used country code digits within bits 17-26 (supporting 3-digit numbers) and un-used phone number digits within bits 27-64 (supporting 12-digit numbers) can be filled by adding leading zeros or trailing zeros or both, as desired. In addition, because bits 27-64 support only 11 digits that can range from 0-9 due to the number of possible phone number combinations, the first digit of a 12-digit phone number, such as used in Germany, can be stored in bits 17-26 along with a non-three-digit country code. As described below, other features and variations can be implemented, if desired, and related systems and methods can be utilized as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A is block diagram for a system including an ISO 11784/85 compatible pet tag and a pet tag reader where a phone number is used as the unique pet identifier (ID) number within the ISO 11784 standard code structure.

FIG. 1B is a block diagram for an ISO 11784/85 compatible pet tag including memory circuitry storing a ISO 11784 code structure with phone codes.

FIG. 1C is block diagram for an environment in which a pet tag inserted into a pet with a phone number pet ID number is used to directly contact a pet owner in case of a lost pet.

FIG. 2A (Prior Art) is a block diagram for a system including an ISO 11784/85 compatible pet tag and a pet tag reader according to the ISO 11784/85 standard.

FIG. 2B (Prior Art) is a block diagram for a system including a pet tag and a pet tag reader according to the ISO 14223 standard.

### DETAILED DESCRIPTION OF THE INVENTION

Systems and methods are disclosed for identifying animals with radio frequency identification transponders using phone information stored in an ISO 11784 compatible code structure in ISO 11784/85 compatible implantable transponders. As described further below, phone number related country codes are stored in bits 17-26 of the ISO 11784 code structure within the memory circuitry within the transponder. And these country codes can be one to three digit country codes as specified in the ITU E.164 standard. Phone numbers are stored in bits 27-64 of the ISO 11784 code structure within the memory circuitry within the transponder. Other embodiments, variations and implementations can be provided as further described below.

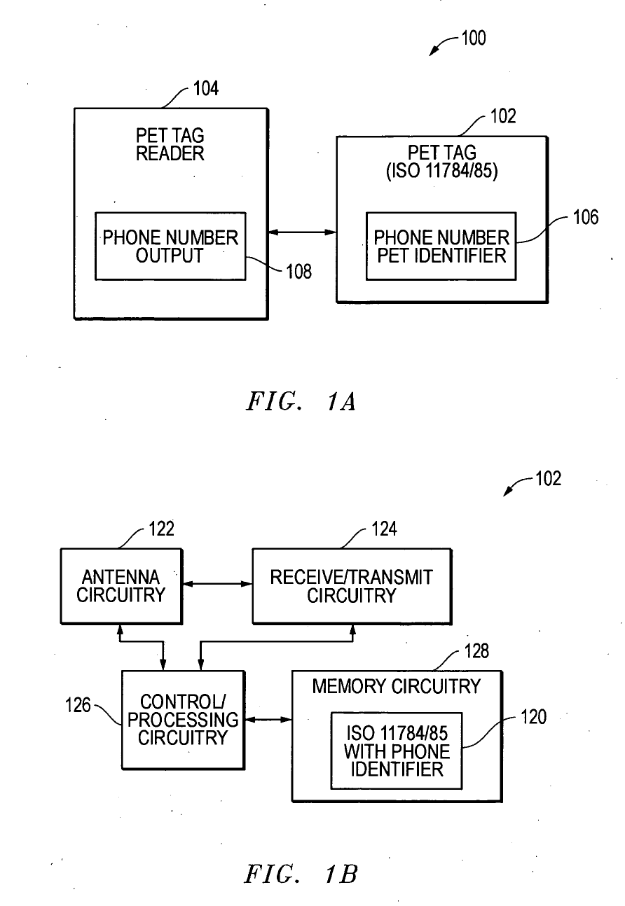

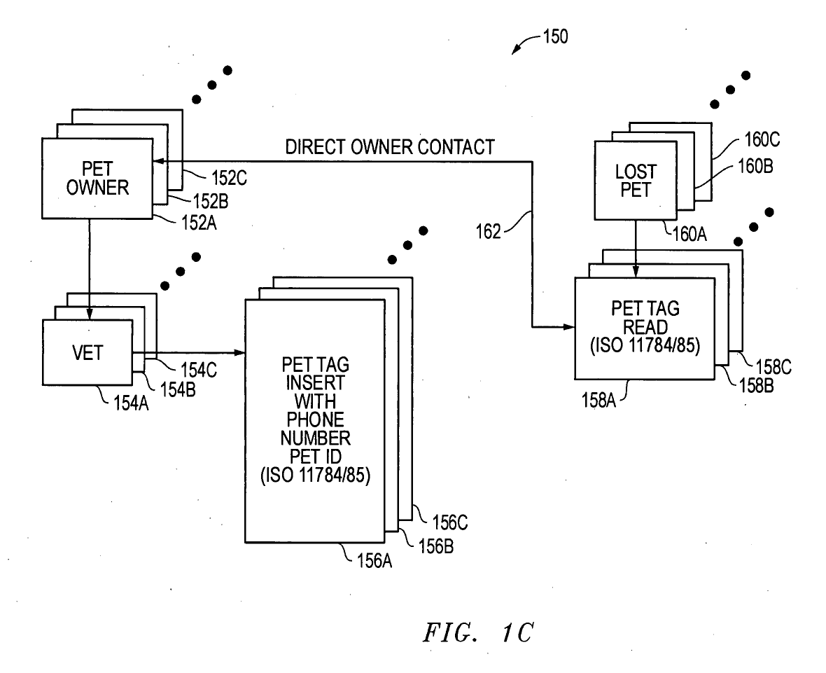

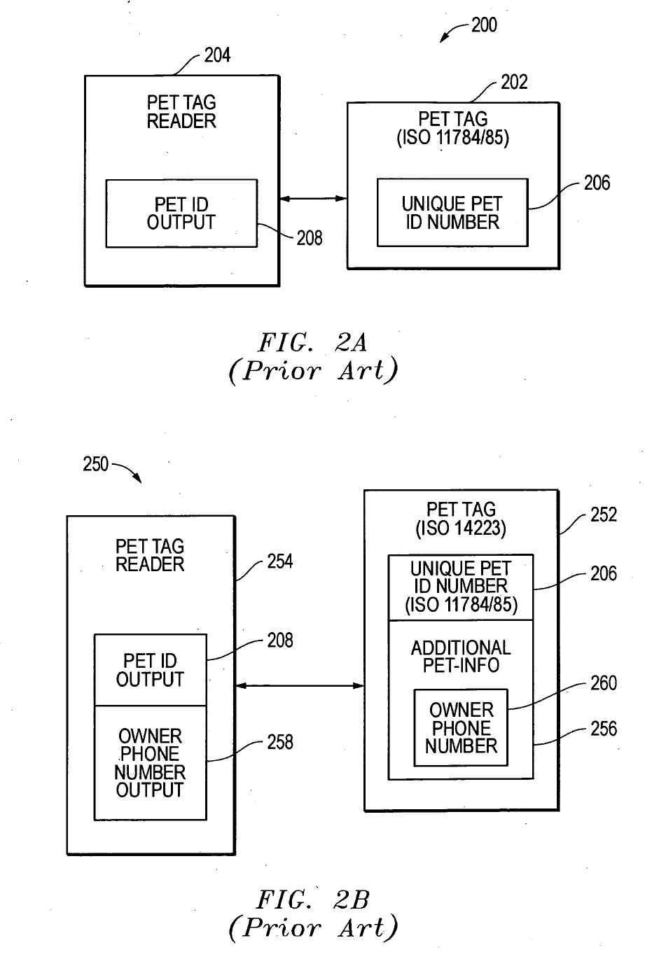

FIG. 1A is block diagram for a system 100 including a pet tag 102 and a pet tag reader 104 where a phone number is used as the unique pet identifier (ID) number within the ISO 11784 standard. As depicted, the pet tag 102 is an ISO 11784 compatible and ISO 11785 compatible pet tag and in part stores pet identification information in the form of phone number information 106 instead of a unique pet identification number and a manufacturer number or ISO 3166 country code as is set forth in the ISO 11784 standard code structure. When the pet tag 102 is read by pet tag reader 104, phone number output 208 is provided by the reader 204 to provide phone number information to the user of the pet tag reader 104.

Where the pet is a lost pet, the locating entity, such as a veterinarian or shelter, can use the phone number to directly contact the owner. Advantageously, this procedure does not require registration of the pet tag with a centralized database because the phone number can be used to contact the owner, and the owner will be able to recognize the pet through description, pictures or otherwise. In addition, the embodiments and methods described herein allow for use of the current base of ISO 11784/85 compatible readers and writers without requiring additional readers. Because the phone number information is programmed into the code structure of the ISO 11784/85 compatible pet tags in place of a unique pet ID code, the ISO 11784/85 compatible readers can read and display the phone number information.

This use of phone number information as the information stored and/or programmed into ISO 11784/85 compatible transponders provide significant advantages over prior solutions that adhere to the ISO 11784 standard code structure and thereby require registration in a centralized database. Although the phone identifier pet tags described herein could still be registered with a centralized database, such registration is not required to provide phone number contact information associated with the pet because the pet tag stores phone number information as described herein.

As discussed above, the ISO 11784 standard code structure provides for the use of an ISO 3166 country code in bits 17-26 and a unique pet identifier number in bits 27-64. In contrast, for the embodiments described herein, these bits are used to hold phone number information including up to a three-digit phone-related country code (e.g., as set forth in ITU-T recommendation E.164) in bits 17-26 and up to a 12-digit subscriber phone number in bits 27-64. It is noted that the phone number country code information described herein according to the E.164 standard is different from the numbers for country codes set forth in the ISO 3166 standard set forth for use in the ISO 11784 standard. It is also noted that bits 27-64 provide 274,877,906,944 number combinations for the phone number. As such, the first digit would need to be set to a 0 or 1 for the remaining digits to be any number from 0 to 9. As such, bits 27-64 can be considered to support an 11-digit phone number where digits 0 to 9 are used for each digit.

Most countries use phone numbers that do not exceed 11-digits. However, Germany is one country that does use some 12-digit phone numbers. In this circumstance, as described below, additional digits within the country code (i.e., bits 17-26) can be used to represent the first digit of the 12-digit phone number in Germany. This modification works well for Germany because Germany has a two-digit country code in the E.164 standard. This modification would also work well, therefore, for any other country that utilized a 12-digit phone number and had been assigned a one- or two-digit country code. It is also noted that other modifications to the use of bits 17-26 and bits 27-64 could also be provided while still using these bits in the ISO 11784 code structure to provide phone number information as contact information for a pet having a ISO 11784/85 compatible pet tag with stored phone number information.

The memory circuitry within an OTP (one time programmable) or read/write transponder can be programmed with the telephone number of the pet owner. Such a number would be unique to the owner, because the telephone communication system is set up in such a way that no duplicate numbers are issued. As such, the ISO 11784 standard code structure is modified by the embodiments described herein so that the following fields are stored in memory circuitry within the pet tag and include phone number information as the pet identifier. Should the owner move, the number programmed in a read-write chip can be updated.

TABLE 2
PHONE ID CODE STRUCTURE

| Bit no. | Information | Combinations |
|---|---|---|
| 1 | Flag for animal (1) or non-animal (0) | 2 |
| | application | |
| 2-15 | Reserved field | 16.384 |
| 16 | Flag indicating the existence of a data block | 2 |
| | (1) or no data block (0) | |
| 17-26 | 3-Digits for Phone Number Country Code | 1.024 |
| | (NOTE - For Germany (or similar country | |
| | phone system), 2-digits for country code, | |
| | 1-digit for first digit in 12-digit phone | |
| | number) | |
| 27-64 | 12-Digits for Phone Number | 274.877.906.944 |
| | (NOTE - First digit would need to be 0 or 1 | |
| | for the rest of the digits to be 0-9.) | |
| | (NOTE - For Germany (or similar country | |
| | phone system), remaining 11-digits of | |
| | 12-digit phone number.) | |

Thus, 15-digits are provided for storage of an international phone number. Currently, no country has a country code longer than a 3-digit code, and currently no country has phone numbers including area codes that exceed 12-digits. However, as noted above, for the rest of the digits to be between 0 and 9, the first digit represented by bits 27-64 would need to be a 0 or 1. This is so because current installed base of ISO 11784/85 compatible readers interpret bits 17-26 as a 3-digit number with 1,024 possible number combinations and interpret bits 27-64 as a 12-digit number with 274,877,906,944 possible number combinations. Thus, for digits that can range from 0-9, bits 17-26 and 27-64 provide adequate storage for 14-digits of an international phone number.

It is noted that non-used digits in a phone number could be addressed by inserting leading zeros or trailing zeros or both. For example, in countries where fewer the 3-digits are need for the country code, leading or trailing 0s could be inserted. For example, Switzerland has 41 as its E.164 country code. As such, 410 or 041 could be programmed into bits 17-26 of the ISO 11784 code structure. The person reading the output would recognize that the leading and/or trailing 0 s could be ignored. Similarly, where fewer than 12-digits are needed for the phone number, leading and trailing 0 s could be inserted. For example, in the United States 10-digit phone numbers are utilized. As such, for the phone number (805) 555-1212, the number 008055551212 or 080555512120 could be programmed into bits 27-64 of the ISO 11784 code structure. (As discussed above, 805555121200 could not be used because the number of combinations using bits 27-64 are limited to 274,877,906,944 phone number combinations so that an “8” in the first digit of a 12-digit number would be too large to be represented.) In this implementation, leading 0 s can be ignored by the person reading the number from the ISO 11784/85 compatible reader, and trailing 0 s will be ignored by the phone system even if dialed. In other words, a phone number (805) 555-1210 stored as 080555512100 would still be handled as (805) 555-1210 by the phone system even if the user dialed (805) 555-1210-0.

As indicated above, at least Germany is a country that does use a full 12-digit phone number. In this situation, because the number of combinations using bits 27-64 are limited to 274,877,906,944 phone number combinations, a modification can be made to accommodate this 12^{th} full digit. The German E.164 country code is 49. As such, only 2-digits are needed in bits 17-26 to represent the German country code. Rather than insert a leading or trailing 0 as the third digit, the third digit can be used for the first digit of the German phone number. For example, the German phone number 82-34-4567-6789 could be represented by programming 498 into the country code bits 17-26 and by programming 023445676789 into the phone number bits 27-64. The user, being informed of this modified usage with respect to Germany, would use 49 as the country code (Germany), 8 as the first digit of the phone number and 23445676789 as the remaining digits of the phone number to achieve the phone number +41 82-34-4567-6789.

It is noted that the country code bits 17-26 could be used for another purpose in a country where the country of origin for the pet would not be in much question. For example, in the United States, where lost pets often do not cross national boundaries, the country code may not be needed. One alternative use for the country code, for example, would be as an indicator that the stored information in bits 27-64 is phone number information rather than a unique pet identifier as set forth in the ISO 11784 standard code structure. For example, an unused country code (e.g., 889) could be programmed into the country code bits 17-26. A veterinarian, shelter or other user could then be informed to recognize this 889 code as an indication that a phone number identifier, rather than a unique pet identifier number, will follow in the output of bits 27-64.

It is further noted that while ISO 11784/85 compatible readers currently read bits 17-26 and 27-64 as a 3-digit and 12-digit number, respectively, these readers could also be reprogrammed so that bits 17-64 are used in a different manner to still provide phone number identifier information for the pet. In addition, reserved bits 2-15 in the ISO 11784 code structure could also be utilized to help provide phone number contact information or to provide an indication that phone information is being output, rather than a unique pet code number, if such reprogramming were implemented.

One advantage of the phone number identification system described herein is that there would be no incentive for anyone to cheat on the system. The purpose of the system is to get animals back home. For example, dogs being registered are often their owners' cherished pets. There is no economic incentive to game the system. The system would also work reliably if there are one or several animals living at a given phone number, because the goal is to get the animal back to his owner, not to distinguish pets owned by the same owner. In addition, this phone identifier method would eliminate the extra step of requiring database registration, a step that perhaps as many as 50 percent of all owners of microchip tagged pets do not make today. Further, the time and hassle on the part of shelters trying to track down microchip numbers to the database where they are registered can be avoided. And this effort in many cases comes up empty, because the animals were never registered and/or the owner has stopped paying registration fees. Still further, animals provided with the phone identification RFID tags described herein could also be fitted with a small plastic tag on its collar indicating that the animal is tagged with a phone ID transponder. Other methods could also be utilized to indicate that an animal has been tagged with a phone ID transponder. This notification would provide notice to the shelter personnel or the scanning veterinarian to look for phone number identification information in the ISO 11784/85 compatible readout.

FIG. 1B is a block diagram for an RFID pet tag 102 having memory circuitry 128 that is storing an ISO 11784 code structure 120 including phone number information as described herein. As depicted, antenna circuitry 122 is coupled to provide signals to and from receive/transmit (transceiver) circuitry 124. Control and processing circuitry 126 is coupled to the receive/transmit circuitry 124 and the memory circuitry 128 to provide signal processing and control for communicating information to and from external RFID readers. The control and processing circuitry 126 is also coupled to the antenna circuitry 122 to provide control of the antenna as well. It is noted that the antenna circuitry 122 is configured to send and receive signals to and from an external RFID reader at desired frequencies, for example, those used by pet tag readers that are compatible with the ISO 11784/85 standard.

FIG. 1C is a block diagram for an environment 250 in which a pet tag 102 inserted into a pet with phone number ID information is used to directly contact a pet owner in case of a lost pet. As depicted, a plurality of pet owners 152A, 152B, 152C . . . can use a plurality of veterinarians (vets) 154A, 154B, 154C to implant pet tags into their respective pets. These pet tags can be programmed before insertion and/or after insertion to include phone number information as a phone number identification for the pet, as represented by elements 156A, 156B, 156C . . . . In other words, phone number information can be stored in the pet tag prior to implantation or after implantation depending upon the type of transponders being utilized. And some transponders allow for reprogramming of information stored in the device. As discussed above, the phone number information is placed in the ISO 11784 code structure using the country code bits and the unique pet identifier bits to hold a phone number related country code and a phone number. When a lost pet 160A, 160B, 160C . . . is located, its pet tag can be read to determine the information stored in the ISO 11784 code structure, as indicated by elements 158A, 158B, 158C . . . , which includes the phone number identification information. As represented by line 162, once this phone number identification information has been read, the locating entity, such as a veterinarian or animal shelter, can initiate a phone call to and make direct contact with the owner of the pet using the phone number information. As indicated above, the phone number information can be any desired phone number that will help provide contact with the owner, such as the phone number of the owner, the phone number of a friend or relative, the phone number of a veterinarian, or some other desired phone number identifier.

It is noted that the phone number identifiers could also be used in the new ISO 14223 compatible transponders, which are also ISO 11784/85 compatible. As described above, the ISO 14233 code structure also includes the legacy ISO 11784 code structure and provides for the storage of the unique pet ID number. As such, ISO 14223 compatible transponders could still take advantage of the phone number identifiers described herein by storing the phone number information in the ISO 11784 code structure portion of the ISO 14223 code structure instead of the unique pet ID number provided for in the ISO 11784/85 and ISO 14223 standards.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for identifying an animal with a radio frequency identification transponder, comprising:
implanting an ISO 11784/85 compatible radio frequency identification transponder having memory circuitry within an animal; and
storing phone number information in an ISO 11784 code structure within the memory circuitry.

2. The method of claim 1, wherein the implanting step occurs before the storing step.

3. The method of claim 1, wherein the storing step occurs before the implanting step.

4. The method of claim 1, further comprising reading phone number information from the ISO 11784 code structure within the memory circuitry and utilizing the phone number information to initiate a telephone call.

5. The method of claim 4, wherein the storing step comprises storing phone number related country codes in bits 17-26 of the ISO 11784 code structure within the memory circuitry.

6. The method of claim 5, wherein the phone number related country codes are one to three digit country codes as specified in the ITU E.164 standard.

7. The method of claim 6, further comprising making a country code less than three digits long into a three-digit number by adding leading zeros or trailing zeros to the country code.

8. The method of claim 1, wherein the storing step comprising storing a phone number in bits 27-64 of the ISO 11784 code structure within the memory circuitry.

9. The method of claim 1, wherein the phone number is represented using 11 or fewer digits.

10. The method of claim 9, further comprising making the phone number into a twelve-digit number by adding leading zeros or trailing zeros or both to the phone number.

11. The method of claim 10, wherein at least one leading zero is used in making the twelve-digit number.

12. The method of claim 1, wherein the storing step comprises storing a one or two digit phone number related country code in bits 17-26 of the ISO 11784 code structure within the memory circuitry, storing at least one digit of a phone number in bits 17-26 of the ISO 11784 code structure within the memory circuitry, and storing a phone number in bits 27-64 of the ISO 11784 code structure within the memory circuitry.

13. The method of claim 12, wherein the storing step comprises storing 49 as a country code representing Germany, storing a first digit of a twelve-digit German phone number as a third digit in bits 17-26 of the ISO 11784 code structure, adding a leading zero to the remaining eleven digits of the twelve-digit German phone number to form a twelve-digit number, and storing the twelve-digit number in bits 27-64 of the ISO 11784 code structure.

14. The method of claim 1, wherein the storing step comprises storing phone number related country codes as specified in the ITU E.164 standard in bits 17-26 of the ISO 11784 code structure within the memory circuitry and storing a phone number in bits 27-64 of the ISO 11784 code structure within the memory circuitry.

15. A method for identifying an animal with a radio frequency identification transponder, comprising: reading phone number information from a ISO 11784 code structure stored within memory circuitry within an ISO 11784/85 compatible radio frequency identification transponder implanted within an animal.

16. The method of claim 15, further comprising utilizing the phone number information to initiate a telephone call.

17. The method of claim 15, wherein the reading step comprises reading a phone number related country code as specified in the ITU E.164 standard from bits 17-26 of the ISO 11784 code structure stored within the memory circuitry and reading a phone number from bits 27-64 of the ISO 11784 code structure stored within the memory circuitry.

18. A radio frequency identification transponder for animals, comprising:
transceiver circuitry configured to communicate with an external radio frequency identification reader;
memory circuitry coupled to the transceiver and configured to store an ISO 11784 code structure; and
phone number information stored in the ISO 11784 code structure within the memory circuitry.

19. The radio frequency identification transponder of claim 18, wherein a phone number related country code is stored in bits 17-26 of the ISO 11784 code structure within the memory circuitry.

20. The radio frequency identification transponder of claim 19, wherein the phone number related country code is a one to three digit country code as specified in the ITU E.164 standard.

21. The radio frequency identification transponder of claim 18, wherein a phone number is stored in bits 27-64 of the ISO 11784 code structure within the memory circuitry.

22. The radio frequency identification transponder of claim 21, wherein the phone number is represented using 11 or fewer digits.

23. The radio frequency identification transponder of claim of 18, wherein a phone number related country code is stored in bits 17-26 of the ISO 11784 code structure within the memory circuitry, wherein the country codes is a one or two digit country code as specified in the ITU E.164 standard, and wherein at least one digit of a phone number is also stored in bits 17-26 of the ISO 11784 code structure within the memory circuitry.

24. The radio frequency identification transponder of claim 18, wherein a phone number related country code as specified in the ITU E.164 standard is stored in bits 17-26 of the ISO 11784 code structure within the memory circuitry and wherein a phone number is stored in bits 27-64 of the ISO 11784 code structure within the memory circuitry.

25. The radio frequency identification transponder of claim 24, wherein leading or trailing zeros or both are used so that three-digits including the country code are represented in bits 17-26 of the ISO 11784 code structure and twelve-digits including the phone number are represented in bits 27-64 of the ISO 11784 code structure.

26. The radio frequency identification transponder of claim 18, wherein the memory circuitry is further configured to store additional fields provide in an ISO 14223 code structure.
